(19) United States
(12) Patent Application Publication
(10) Pub. No.: US 2006/0272883 A1
(43) Pub. Date: Dec. 7, 2006

(54) Power steering device

(76) Inventors: Shuji Shin, Tokyo (JP); Hiroki Hasegawa, Tokyo (JP); Takaaki Tsutsui, Tokyo (JP)

Correspondence Address: RABIN & Berdo, PC, 1101 14TH STREET, NW, SUITE 500, WASHINGTON, DC, 20005, US

(21) Appl. No.: 11/434,116

(22) Filed: May 16, 2006

(30) Foreign Application Priority Data
Jun. 6, 2005 (JP) 2005-165195

(51) Int. Cl. B62D 5/06

(52) U.S. Cl. 180/428

(57) ABSTRACT

A power steering device includes: a guide rod (1); a piston (3); a cylinder (2); a transmission mechanism (8, 9, 10) fixed to the cylinder (2), which transmits a steering force by moving integrally with the cylinder (2); a rack shaft (16) provided substantially parallel to the cylinder (2), which moves integrally with the cylinder (2); a pinion (18) provided on an input shaft (23) connected to a steering wheel, the pinion (18) engaging with a rack (25) of the rack shaft (16); and a valve mechanism (24) which causes one of the pressure chambers (4, 5) to communicate with a pressure source and another of the pressure chambers (4, 5) to communicate with a tank in accordance with a rotational load of the pinion (18) in relation to the rack (25).

### FIELD OF THE INVENTION

This invention relates to a power steering device using a rack and pinion system.

### BACKGROUND OF THE INVENTION

JP11-321694A, published by the Japan Patent Office in 1999, discloses a steering device. In this device, a rack shaft is provided integrally with a piston rod of a power cylinder. In other words, in this conventional device, the rack shaft and piston rod are provided in series such that the rack shaft and piston rod are moved integrally according to the output of the power cylinder.

A tie rod is linked to the rack shaft. The tie rod is substantially parallel to the rack shaft. When the rack shaft is moved by the force of the power cylinder, the resultant force is transmitted to a knuckle arm via the tie rod, and thus a desired assist force is generated.

### SUMMARY OF THE INVENTION

In the device described above, the rack shaft and piston rod are provided integrally, causing an increase in the axial direction length.

When the axial direction length of the device increases, a problem arises in that it becomes impossible to dispose the power steering device in a vehicle having a narrow width, for example.

It is therefore an object of this invention to provide a power steering device in which the axial direction length can be reduced.

In order to achieve the above object, this invention provides a power steering device, the power steering device comprises a guide rod fixed to a vehicle body, a piston provided integrally with the guide rod, a cylinder housing the piston, an interior of the cylinder being divided into a pair of pressure chambers by the piston, a transmission mechanism fixed to the cylinder, which transmits a steering force by moving integrally with the cylinder, a rack shaft provided substantially parallel to the cylinder, which moves integrally with the cylinder, a pinion provided on an input shaft connected to a steering wheel, the pinion engaging with a rack of the rack shaft, and a valve mechanism which causes one of the pressure chambers to communicate with a pressure source and another of the pressure chambers to communicate with a tank in accordance with a rotational load of the pinion in relation to the rack.

The details as well as other features and advantages of this invention are set forth in the remainder of the specification and are shown in the accompanying drawings.

### BRIEF DESCRIPTION OF THE DRAWINGS

FIG. 1 is a plan view showing a power steering device according to an embodiment.

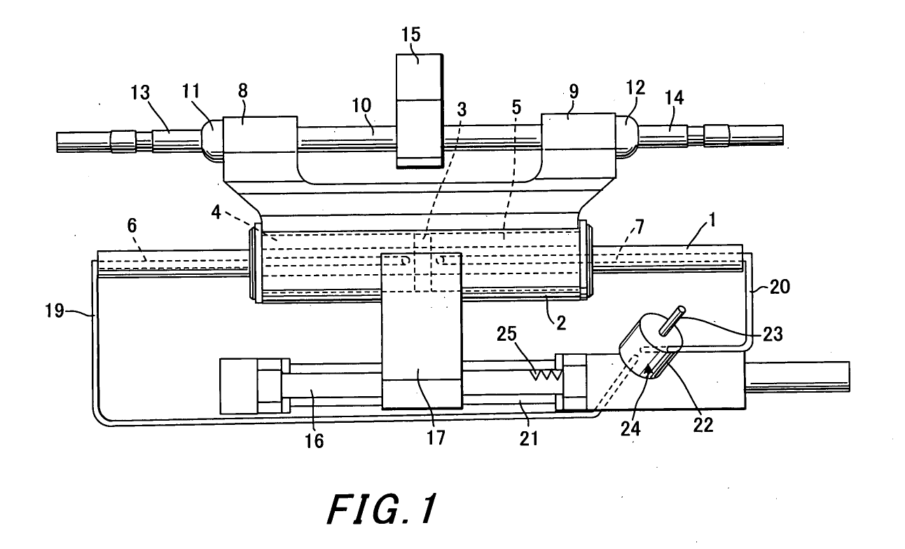

FIG. 2 is a side view showing the power steering device according to this embodiment.

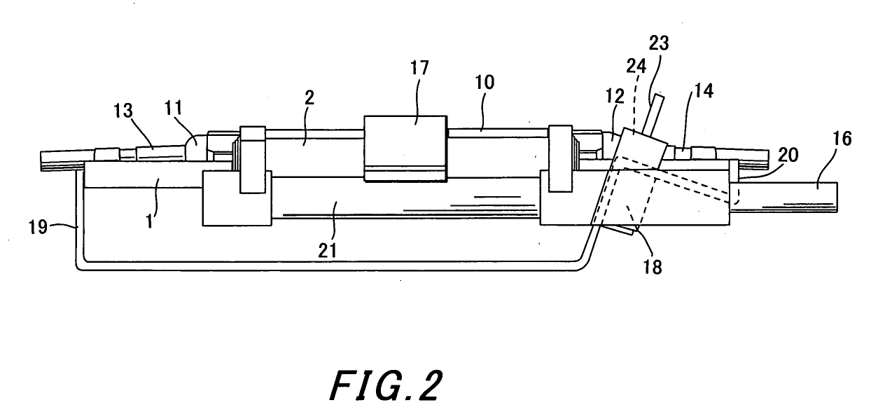

### DESCRIPTION OF THE PREFERRED EMBODIMENT

This invention will be described below with reference to the drawings. A piston 3 is fixed to a guide rod 1 which is fixed to a vehicle body, and a cylinder 2 is attached slidably to the guide rod 1. The interior of the cylinder 2 is divided into a pressure chamber 4 and a pressure chamber 5 by the piston 3. A pair of through holes 6, 7 are formed in the guide rod 1 along its shaft axis. One end of each through hole 6, 7 opens near the respective sides of the piston 3, while the other end is connected to a valve mechanism 24 to be described below.

A pair of brackets 8, 9 are provided on the cylinder 2 with a gap therebetween, and an output shaft 10 is fixed to the brackets 8, 9. The output shaft 10 is supported by the brackets 8, 9 parallel to the guide rod 1. Thus, when the cylinder 2 moves along the guide rod 1, the output shaft 10 also moves axially.

Rods 13, 14 are connected to the respective ends of the output shaft 10 via inner ball joints 11, 12. Right and left knuckle arms are connected to the rods 13, 14 respectively. A support member 15 is fixed to the vehicle body so as to support the output shaft 10 slidably. Axial movement of the output shaft 10 enables steering corresponding to the movement direction.

An output transmission mechanism of this embodiment is constituted by the brackets 8, 9 and output shaft 10. Here, the output transmission mechanism may take any constitution in which a force generated by movement of the cylinder 2 is converted into a steering force by an output transmission mechanism which moves in parallel with the cylinder 2.

Further, a rack shaft 16 is provided parallel to the guide rod 1 and supported by a support member 17 and a guide member 21 so as to be capable of axial movement integrally with the cylinder 2. A rack 25 formed on the rack shaft 16 meshes with a pinion 18 provided in a gear case 22. An input shaft 23 connected to a steering wheel is connected to the pinion 18.

Further, a valve mechanism 24 is provided between the pinion 18 and input shaft 23. The valve mechanism 24 switches a hydraulic flow passage in accordance with a rotational load of the pinion 18 in relation to the rack 25 provided on the rack shaft 16. The through holes 6, 7 are connected to the valve mechanism 24 via pipes 19, 20. When the flow passage of the valve mechanism 24 is switched in accordance with the steering direction of the steering wheel, one of the two pressure chambers 4, 5 communicates with a pump serving as a pressure source, while the other pressure chamber communicates with a tank.

Next, an action of this embodiment will be described. When the steering wheel is manipulated, the flow passage of the valve mechanism 24 is switched according to the steering direction. In accordance with the direction of the switch, one of the pressure chambers in the cylinder 2, for example the pressure chamber 4, is caused to communicate with the pressure source while the other pressure chamber 5 is caused to communicate with the tank. As a result, the cylinder 2 moves in a leftward direction of the drawing.

When the cylinder 2 moves in the leftward direction of the drawing, the output shaft 10 and rack shaft 16 also move in the leftward direction of the drawing. At this time, the rack shaft 16 causes the pinion 18 to rotate while following with the cylinder 2. Thus, as the cylinder 2 moves, the output shaft 10 and rods 13, 14 move, enabling steering in accordance with the movement direction.

According to this embodiment, the cylinder 2 is moved in relation to the fixed guide rod 1, and hence the axial direction length of the entire cylinder is reduced below that of a case in which the piston rod is moved.

When the piston rod is moved, the two ends of the piston rod serve as stroke starting points when the piston rod is in a neutral position, and hence the length of the entire cylinder increases excessively by the length of the stroke from the two ends of the piston rod.

On the other hand, by moving the cylinder 2 in relation to the guide rod 1 as in this embodiment, the maximum axial direction length of the entire cylinder corresponds to the length of the guide rod 1. In other words, the guide rod 1 need only be as long as the stroke of the cylinder 2, and therefore the maximum length of the entire cylinder is shorter than that of a case in which the piston rod is moved.

Further, in this embodiment the guide rod 1 and output shaft 10 are provided in parallel, and the guide rod 1 and rack shaft 16 are also provided in parallel. Hence, the axial direction length is shorter than that of a conventional case in which the piston rod 1′ and rack shaft 16 are provided integrally and in series.

According to the embodiment described above, the axial direction length of the entire device is shortened, and hence the device can be disposed in a vehicle having a narrow width or a vehicle having little disposal space in the width direction.

Further, the pressure chamber 4 and pressure chamber 5 of the cylinder 2 are caused to communicate with the power source and tank, respectively, via the through holes 6, 7 formed in the guide rod 1, eliminating the need for pipes which move together with the cylinder 2. As a result, an improvement in disposal efficiency can be achieved.

What is claimed is:

1. A power steering device comprising:
a guide rod fixed to a vehicle body;
a piston provided integrally with the guide rod;
a cylinder housing the piston, an interior of the cylinder being divided into a pair of pressure chambers by the piston;
a transmission mechanism fixed to the cylinder, which transmits a steering force by moving integrally with the cylinder;
a rack shaft provided substantially parallel to the cylinder, which moves integrally with the cylinder;
a pinion provided on an input shaft connected to a steering wheel, the pinion engaging with a rack of the rack shaft; and
a valve mechanism which causes one of the pressure chambers to communicate with a pressure source and another of the pressure chambers to communicate with a tank in accordance with a rotational load of the pinion in relation to the rack.

2. The power steering device as defined in claim 1, wherein an interior of the guide rod comprises a pair of through holes, one end of each through hole being connected to the valve mechanism while another end communicating with the pressure chambers.
